(19) United States
(12) Patent Application Publication
(10) Pub. No.: US 2005/0193285 A1
(43) Pub. Date: Sep. 1, 2005

(54) Method and system for processing fault information in NMS

(76) Inventor: Eung-Sun Jeon, Seoul (KR)

Correspondence Address: Robert E. Bushnell;Suite 300, 1522 K Street, N.W., Washington, DC, 20005, US

(21) Appl. No.: 11/008,293

(22) Filed: Dec. 10, 2004

(30) Foreign Application Priority Data
Feb. 11, 2004 (KR) 2004-9119

(51) Int. Cl. G06F 11/00

(52) U.S. Cl. 714/48

(57) ABSTRACT

A method in which a network management system (NMS) processes information on a fault, such as numerous alarms or events, generated from high-capacity network equipment and forwards the processed fault information to a client in real-time. More particularly, the present invention relates to a fault information processing method and system for processing alarms more rapidly and efficiently using database table modeling to improve a delay in storing data in an alarm database in applications, which is most problematic in processing alarms and events. With the present invention, the temporary storage of the traps in the listener table is simply performed by the fault management module and other additional functions spending time are performed by adopting an asynchronous transaction processing manner through the listener daemon module in order to more rapidly and quickly process a large amount of alarm and event information which could not be satisfied in an existing synchronous manner, thereby realizing real-time processing of a number of traps.

### CLAIM OF PRIORITY

This application makes reference to, incorporates the same herein, and claims all benefits accruing under 35 U.S.C. § 119 from an application for THE SYSTEM AND METHOD FOR THE ALARM AND EVENT MANAGEMENT IN EMS earlier filed in the Korean Intellectual Property Office on 11 Feb. 2004 and there duly assigned Serial No. 2004-9119.

### BACKGROUND OF THE INVENTION

1. Field of the Invention

The present invention relates to a method in which a network management system (NMS) processes information on a fault, such as numerous alarms or events, generated from high-capacity network equipment and forwards the processed fault information to a client in real-time and, more particularly, to a fault information processing method and system for processing alarms more rapidly and efficiently using database table modeling to improve a delay in storing data in an alarm database in applications, which is most problematic in processing alarms and events.

2. Description of the Related Art

Generally, a network management system is used to manage a network to which a number of systems are connected. Accordingly, the network management system is directly and indirectly connected to each of the systems making up the network, and receives status information of each system to manage the system. Further, this status information can be confirmed on each operator's computer connected to the network management system.

The systems connected to the network management system include a switching system, a transmission system, etc. The network management system is connected to the switching system and the transmission system to collect fault data and maintenance data from each of the systems and to manage the data as a database.

In the earlier art, the fault data is processed in real-time in a synchronous manner. The term ‘synchronous’ refers to a manner in which, when a trap which means an alarm or an event is generated, a fault management module receives the trap, processes the data in a storable format and then stores the processed data collectively in a database table within a system.

That is, a synchronous manner means that steps from the step of receiving a trap to the step of storing the trap in a database table as a final step are performed in sequence, namely, that the steps are not performed in separate processes.

FIG. 1 is a diagram illustrating a synchronous alarm and event processing system according to the earlier art. A network management system 100 always monitors the status of a communication network to maintain the network in an optimal status, collects and accumulates the status, fault, traffic data, or the like of the network, stores a plurality of fault information generated in the network, and provides desired fault information to clients 170, which are a plurality of fault management computers interworked with the network management system 100.

That is, when the fault information, or a trap, generated in the network arrives at the network management system 100, the network management system 100 stores and manages the trap in a database table to provide proper information responsive to a request from the client 170.

As shown, the network management system 100 according to the earlier art includes a fault management module 110 for storing fault information received from an external system in a database table, a listener daemon module 120 for performing additional tasks for listeners, a listener table 130 for serving to temporarily store traps received from the exterior, an alarm table 140 and an event table 150 for receiving and storing data regarding alarms or events from the listener table 130, and a client list table 160 for managing individual clients 170 and storing a list of the clients.

According to the earlier art, the network management system 100 stores traps received from the exterior in the listener table 130, which may be understood as a temporary storage space, and then updates the alarm table 140 and the event table 150 with the received traps.

That is, in the earlier art, upon receiving traps due to generation of network fault, fault generation histories were updated in the alarm table 140 and the event table 150 by the fault management module 110 in the network management system 100. Such an update was performed along with the process in which the received traps are stored in the listener table 130.

To this end, the listener database has the listener table, which is a fault information recognizing space for the individual clients 170. The clients 170 can read the fault information from the listener table allocated to the clients and recognize the fault generation, which is realized by fault managers that are application programs driven within the client 170 PC.

That is, if the client runs the fault manager to process a real-time event, a table is allocated to the fault manager, which is a listener within the database created by the server. The listener table will be created by the number of the driven fault managers. This is aimed at forwarding results of independent tasks performed by each fault manager.

In the fault management according to the earlier art, the fault management module 110 is composed of a trap receiving daemon, for performing several additional tasks in addition to storing pure trap information upon storing data. Typically, a daemon is a program that runs continuously and exists for the purpose of handling periodic service requests that a computer system expects to receive. The daemon program serves to execute tasks related to system operation while operating in a background state and to properly forward the collected requests to be processed by other programs or processes.

Thus, the trap-receiving daemon, which is a fault management daemon application program, stays in a background state and then starts to operate automatically, and executes a necessary task when a condition of the task to be processed is generated. For example, when receiving a release alarm, the fault management module 110 as the trap-receiving daemon finds a corresponding alarm among existing generated and stored alarms using alarm generation information such as a location, a time or the like, and writes the release of the alarm or performs an alarm summary task for indicating a representative alarm on an upper network map.

In the synchronous trap processing structure according to the earlier art, such an additional function is performed whenever each trap is generated. That is, the respective clients 170 receive the traps processed as described above, using a polling method and display that information on a screen.

Polling is derived from the meaning that clients inquire the listener table 130 in the database to confirm whether newly arrived alarm information exists and then fetch the data periodically.

The alarm table 140 stores and manages all alarm data generated in the network and the event table 150 stores all events other than the alarms generated in the network.

The listener table 130 is a table that temporarily stores all traps (e.g., alarms or events) generated in the equipment so that the clients 170 can poll the traps. The listener table 130 serves to forward real-time traps of a polling manner to the clients 170. To this end, the listener table 130 temporarily stores all of the generated traps, and each of the clients 170 receives trap information by periodically polling the listener table 130.

The listener daemon (LD) module 120 periodically deletes the trap information in the listener table 130 already read out by all clients 170 using the last read alarm sequence number while managing the list of all clients that have requested polling.

At this time, the last read alarm sequence number means a sequence number of the last read alarm upon periodic alarm polling by the clients, and is called the last sequence (last_seq). In other words, a serial number is given to each of newly forwarded alarms while parsing the alarm. This number is an incremental natural number, and sequential numbers such as 1, 2, 3, 4, 5, 6 . . . are applied to the forwarded alarms.

For example, if one client polls ten alarms 1, 2, 3, 4, 5, 6, 7, 8, 9 and 10 which newly arrive at the listener table 130, then the last sequence (last_seq) is 10.

In the conventional synchronous alarm processing method, it is required to perform certain related tasks prior to final storage of every generated alarm information in order to forward alarm information in real-time. For example, each of the clients 170 cannot poll the alarms until the tasks are performed, such as releasing an alarm, processing a representative alarm, or incrementing an alarm count for an alarm generated in an overlapping manner.

To this end, the trap-receiving daemon 110 performs a single commit for storing the alarms in the tables 130, 140 and 150. The respective clients 170 cannot poll the alarms until the single commit is performed. Commit means the update of a database performed when the transaction is successfully completed.

Meanwhile, the trap information stored in the tables 130, 140 and 150 is periodically deleted by an SQL delete statement only with respect to the alarms read by all clients 170. This significantly reduces the number of alarms that can be processed per second because much time is spent due to additional tasks in processing congesting alarms in real-time.

Expanding the size of a network and a range of management in a geometric progression requires a network management system (NMS) capable of managing a high-capacity network. An alarm manager which is one of NMS functions making high-capacity processing possible must be able to process far more traps (e.g., a minimum of 200 TPS) than the number of traps (e.g., 20 to 30 TPS) that can be processed in a conventional configuration developed for small systems.

As described above, in the earlier art, fault generation histories were updated in the alarm table 140 and the event table 150 by the fault management module 110, which is a trap-receiving daemon, upon receiving traps due to the generated network fault, and the update was performed along with the process in which the received traps are stored in the listener table 130.

In addition, in the earlier art, the above-stated processes performed by the fault management module 110 upon trap reception were independently performed whenever individual alarms or events are generated. That is, in the earlier art, there was a problem in that a trap-processing time is delayed due to the process repeated whenever one alarm is generated.

### SUMMARY OF THE INVENTION

It is, therefore, an object of the present invention to provide a method and system for processing fault information in NMS, allowing real-time fault information processing by periodically and collectively processing a number of traps using an asynchronous manner and a bulk commit manner in order to more rapidly forward a lot of alarm and event information, which could not be satisfied by an existing synchronous manner, to an operator in a network system having increasingly high-capacity.

It is another object of the present invention to provide a temporary storage of the traps in the listener table that is simply performed by the fault management module and other additional functions spending time which are performed by adopting an asynchronous transaction processing manner through the listener daemon module in order to more rapidly and quickly process a large amount of alarm and event information which could not be satisfied in an existing synchronous manner, thereby realizing real-time processing of a plurality of traps.

It is yet another object of the present invention to provide a method and system for processing fault information that is both easy and inexpensive to implement and yet have greater efficiency.

In order to achieve the above and other objects, the present invention is based on a network management system having the following individual modules. That is, the network management system according to the present invention is composed of an alarm table for storing and managing alarms, an event table for storing and managing event-wise information, a listener table, that is, a temporary trap storing database for polling of a client alarm manager, a client list table for managing a list of connected clients, a fault management module for storing fault information received from the external system in the listener table, and a listener daemon (LD) module for storing and forwarding only information on alarm itself in real-time in an asynchronous manner and allowing additional tasks to be performed as background tasks upon alarm generation to enhance a real-time alarm processing speed.

According to the present invention, if an alarm or event is generated from a network, the alarm and event is forwarded to a trap-receiving daemon module, which is a fault management module in a network management system. The trap-receiving daemon module processes and stores the generated trap in a database.

The present invention is characterized in that the real-time alarm processing speed is enhanced by improving database table modeling designed for existing alarm processing and applying an asynchronous alarm forwarding manner.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram illustrating a synchronous alarm and event processing system according to the earlier art;

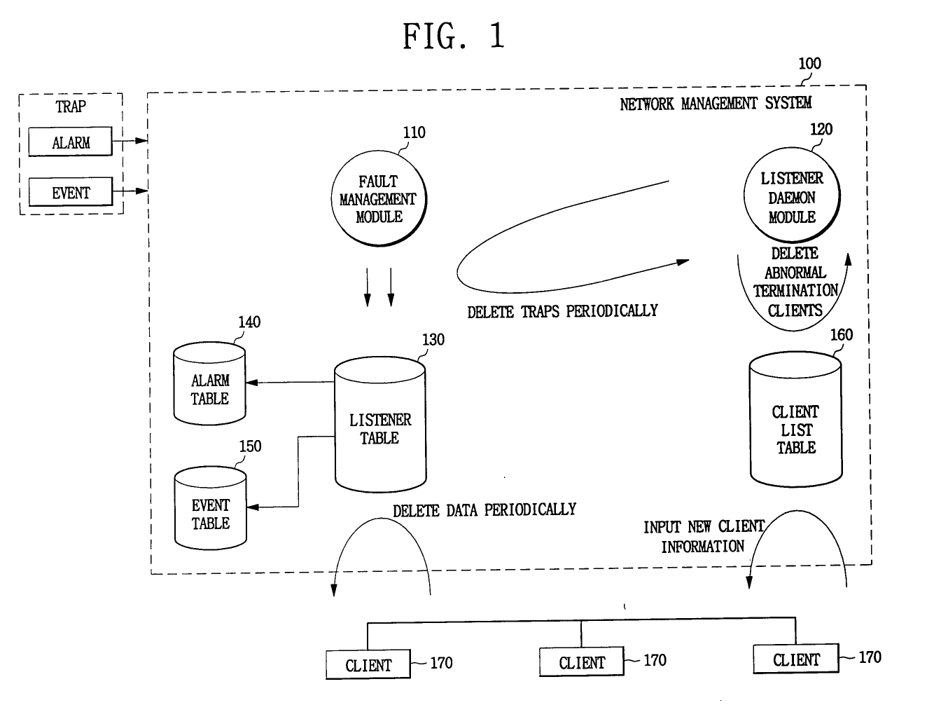

FIG. 2 is a diagram illustrating an asynchronous alarm and event processing system according to the present invention; and

FIG. 3 is a diagram illustrating an asynchronous fault generation information handling process according to the present invention.

### DETAILED DESCRIPTION OF THE INVENTION

Hereinafter, preferred embodiments of the present invention will be described in detail with reference to the accompanying drawings. If detailed discussion on known related functions or configurations is determined to make the subject matter of the present invention to be ambiguous unnecessarily in describing the present invention below, it will be omitted. Terms described below are terms defined by consideration of their function in the present invention. The definition should be determined based on the contents described herein, since it may be changed according to the intention of a user, practice, or the like.

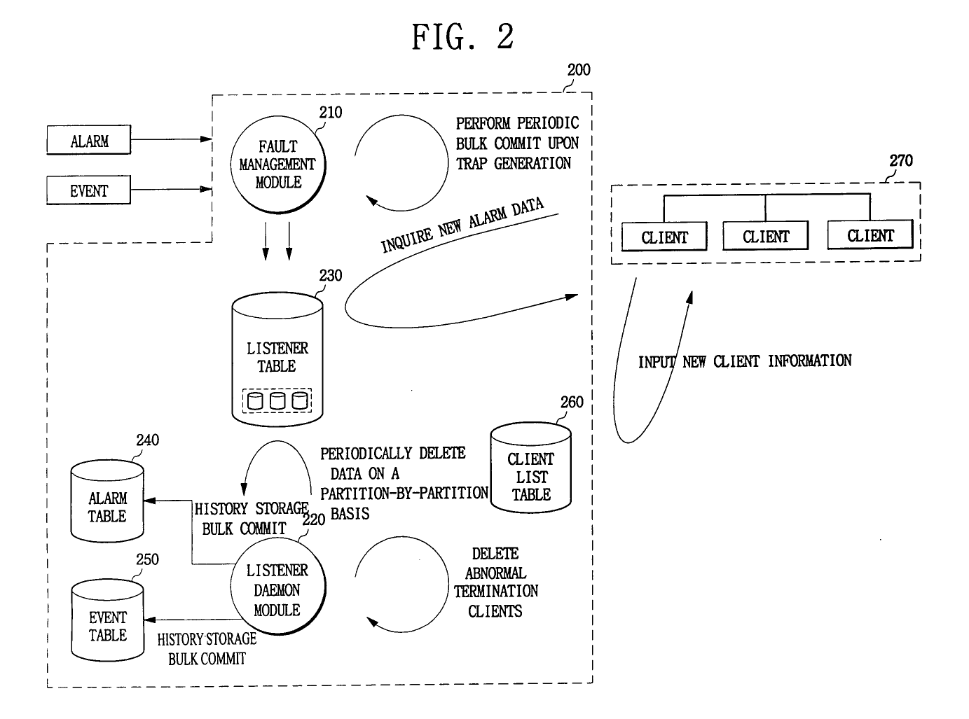

FIG. 2 is a diagram illustrating an asynchronous alarm and event processing system 11 according to the present invention. As shown, the present invention is composed of a fault management module 210 for storing fault information received from an external system in a listener table 230, the listener table 230 which is a temporary trap storage database for a client alarm manager polling, an alarm table 240 for storing and managing alarms, an event table 250 for storing and managing event-wise information, a client list table 260 for managing a list of connected clients, and a listener daemon module 220 for performing history management in an asynchronous manner by collectively sending the fault information to the alarm table and the event table in real-time while generating an alarm.

A trap-receiving daemon, which is the fault management module 210, is a unit at which an alarm generated in equipment arrives first. The greatest role of the trap-receiving daemon is to parse alarm data into a format storable in the database. The daemon also performs a bulk commit periodically and stores a data package in the listener table 230.

At this time, parsing refers to processing the alarm data generated in the system to be a format storable in the database. In addition, commit is a concept similar to an insert, in which the insert means putting data in a table, not storing. The commit means storing the data finally, in which the data is not stored finally until the commit is performed.

Meanwhile, in the manner of performing final storage each time the data is written by the insert as described above, a writing task on a disk is performed every time, which spends much time. Accordingly, the present invention is characterized by performing data storage by the bulk commit collectively storing a data package at a time.

The listener daemon module 220 is a program in a server that performs several additional functions of the listener table 230, and performs asynchronous alarm information processing according to the present invention. The asynchronous alarm information processing means, unlike a synchronous manner in the earlier art, includes a process of collecting and storing fault information in the listener table by the fault management module 210, and a process of updating the fault information in the alarm table 240 and the event table 250 by the listener daemon module 220 that are separately performed. This is intended to prevent a delayed processing time encountered when depending on the conventional synchronous manner.

The listener daemon module 220 is adapted to increase an alarm information processing speed by performing the bulk commit and periodic data deletion on a partition-by-partition basis, which are the characteristics of the present invention.

The listener table 230, as stated earlier, is a table present in the database, in which the table may be understood as a certain space for storing data. The listener table 230 is a term defined by the present invention, which means that all clients observe the listener table 230 to confirm whether alarm information arrives or not. That is, if an alarm is generated, it will be immediately stored in the listener table 230 and all of the clients will read the listener table 230 and fetch the desired alarm information.

The alarm table 240 and the event table 250 receive and finally store data regarding an alarm or event from the listener table 230.

In operation, each of the clients 270 is given with its unique identifier (ID) number for distinguishing respective clients 270, and the identifier (ID) numbers are composed of sequential numbers given by the database (e.g., 1, 2, 3, . . . ).

The clients 270 are managed by the identifier (ID) numbers given as described previously. A table storing and managing the list of the thus driven clients 270 is a client list table 260 in the database.

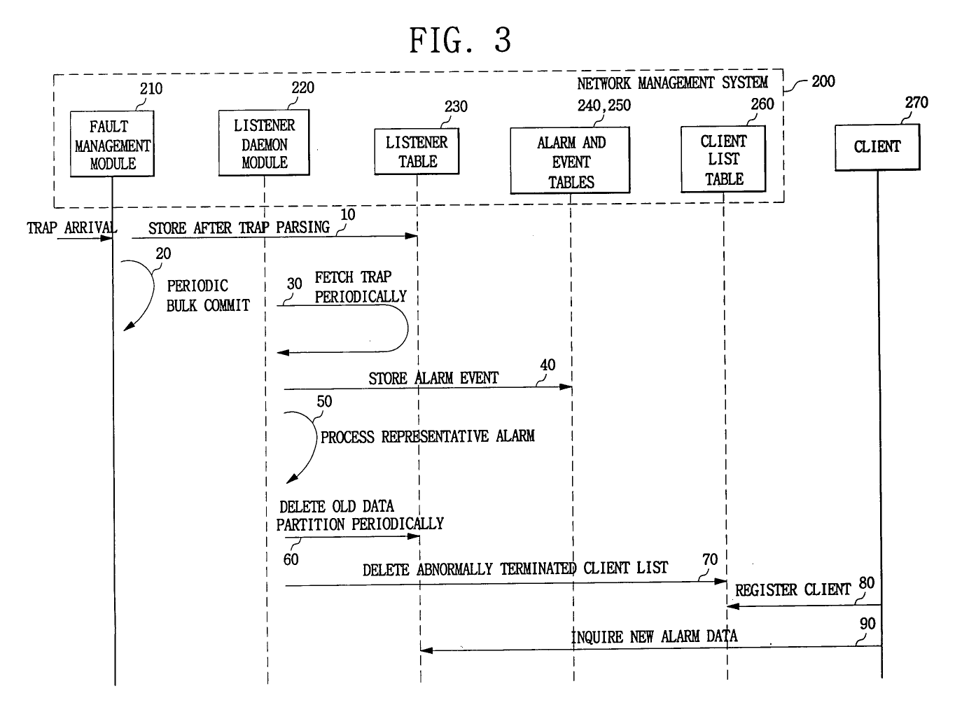

FIG. 3 is a diagram illustrating an asynchronous fault generation information handling process according to the present invention.

As described above, the present invention is characterized in that a trap-receiving daemon as the fault management module 210 stores the arrived traps in the listener table 230, namely, the database when the traps are generated from the network, and that the listener daemon module 220 periodically performs the bulk commit and data deletion to the traps on a partition-by-partition basis as a separate procedure after storing the traps.

At this time, the client 270 will be able to recognize network fault generation by periodical trap polling in the listener table 230.

The process will be discussed in more detail. First, if a trap generated in the network arrives at the fault management module 210, the fault management module 210 parses the arrived trap data into a storable format and then temporarily stores it in the listener table 230 (10).

As described previously, the parsing refers to processing the alarm data generated in the system into a format storable in the database, and usually to analyzing whether functions of words in an input sentence are grammatically correct.

When a trap arrives, a timer, which is an additional program thread in the fault management module 210, is driven for the fault management module 210 to perform the bulk commit periodically (e.g., every one second) (20).

The bulk commit refers to collectively storing a data package at one time, and is intended to prevent processing speed degradation caused due to individual storage of the received trap data.

The listener daemon module 220 is a program in a server that periodically performs the bulk commit and the data deletion on a partition-by-partition basis, which are the characteristics of the present invention. The listener daemon module 220 periodically fetches all trap information following the last sequence (last_seq) from the listener table 230 (30). The last sequence (last_seq), as stated earlier, means the sequence number of the last alarm that is read when the clients periodically perform alarm polling.

Periodically fetching all traps following the last sequence (last_seq) means periodically retrieving (polling) the listener table 230 to fetch newly arrived alarms. The last sequence (last_seq) is used to distinguish the newly arrived alarms.

The listener daemon module 220 suffices to fetch only a number larger than the last alarm sequence number which it has read right before. For example, it is assumed that alarm sequence numbers (alarm seq_no), such as 1, 2, 3, 4, 5, 6, 7, 8, 9, 10, 11 and 12, are now present in the listener table 230. At this time, if the last number is 10 upon previous polling, it needs to fetch only data having alarm numbers larger than 10 and thus only 11, 12 and 13 upon new polling.

The listener daemon module 220 stores the trap information which has been fetched from the listener table 230 as described above, in the alarm table 240 and the event table 250 (40). The listener daemon module 220 stores the trap information, fetched from the listener table 230, in the alarm table 240 when it is an alarm, and records the trap information in the alarm table 240 when fault release or the like is generated. In addition, when overlapped alarm is generated, the listener daemon module 220 accordingly performs a generation count increment.

The alarm table 240 is formed of a table representing the generation or non-generation, generation times, or the like of a particular alarm. Whenever faults are individually generated, the generation release or non-generation release and overlapped generation or non-overlapped generation are recorded in the alarm table and the fault generation information is updated.

Thus, the listener daemon module 220 will perform history management with respect to the fault generation through the update of the fault generation information written to the alarm table 240 according to the generation release or non-release and the overlapping generation or non-overlapping generation.

Such history management by the listener daemon module 220 is performed separate from storing the fault generation information in the listener table 230 by the fault management module 210. That is, in the earlier art, the storage of the fault generation information and the history management are sequentially performed by the fault management module 210, which causes a time delay for the history management.

The present invention performs the history management by the listener daemon module 220, separate from the storage of the fault generation information by the fault management module 210, and stores the updated fault generation information in the alarm table and the event table. At this time, the storage of the updated fault generation information is also performed by the periodic bulk commit, which is accompanied by representative alarm processing described below.

That is, the listener daemon module 220 processes a representative alarm along with the history management from a trap fetched from the listener table 210. The processing of the representative alarm indicates a task of calculating representative alarm information from numerously generated alarms. In the present invention, the representative alarm information is selected by checking the alarms fetched from the listener table 210, and is normally determined by an alarm having the highest alarm class.

That is, the listener daemon module 220 selects an alarm having the most serious fault degree and handles it as the representative alarm. This representative alarm handling makes collective representative alarm selection according to the bulk commit possible.

That is, when storing the trap information fetched from the listener table 230 in the alarm table 240 and the event table 250, the listener daemon module 220 performs the bulk commit in which data is packaged and is collectively processed, and in this process, a class in the data package showing the highest fault degree is selected. Consequently, collective representative alarm selection is performed according to the selected class (50).

The most important function of the listener daemon module 220 includes periodic data partition deletion. The alarm information stored in the listener table 230 is intended for polling by the clients 270. The already polled information should be periodically deleted. Thus, because the stored information is periodically deleted, the storage in the listener table 230 may be understood as temporary storage.

The present invention is characterized by, upon deleting old data, namely, already read data, among alarm information stored in the listener table 230, deleting the stored data group on a partition-by-partition basis without finding and deleting the old data one by one.

At this time, the partitions are created at ten-minute intervals, and alarms contained in the ten minutes are all stored in the same partition. If the time has elapsed, the partition, namely, an old partition of a ten-minute unit is deleted so that data contained in the partition is deleted at one time.

This is intended to enhance a processing speed delay that is caused when finding and deleting the old data one by one as described above, and significant enhancement in the processing speed is possible according to the collective deletion on a partition-by-partition basis (60).

In addition, the listener daemon module 220 periodically deletes a list of abnormally terminated clients from the client list table 260. If the alarm manager has been normally terminated, each of the clients 270 will no longer perform the polling and delete its information from the client list.

However, since this process cannot be performed when the alarm manager has been terminated abnormally, the listener daemon module 220 monitors the abnormal termination and, when the abnormal termination is made, executes a forced routine.

That is, the listener daemon module 220 monitors the client list table 260 and compares the monitoring time to the last polling time of the client 270 to determine whether the abnormal termination is made or not. If it is determined to be abnormally terminated, the listener daemon module 220 deletes the list of abnormally terminated clients from the client list table 260 (70).

The client 270 performs direct network management by connecting to the network management system 200 and collecting necessary network fault information, unlike the program modules 210 to 260 in the network management system 200 as described hereinbefore.

To this end, the client 270 first runs the fault manager, which is an application program driven in the client PC (personal computer), and then registers the running fact on the client list table 260 and receives an allocated unique number (80).

That is, in initial running, the client 270 writes its running time information, and receives an allocated client identifier (client_id), which is an identifier for the client, to register the identifier on the client list table 260.

After registering the identifier on the client list table 260, the client inquires whether new alarm data is present. That is, the client 270 performs polling to confirm whether newly arrived alarm information is present in the listener table 230, and checks whether a number larger than the last sequence (last_seq) number is present as mentioned above to confirm whether the new alarm data arrives (90). In other words, the client 270 will read the last sequence (last_seq), which has been polled by the client, from the client list table 260 and will poll an alarm having a value larger than the last sequence (last_seq) number among alarm sequence numbers (Alarm seq_no) present in the listener table 230.

After having performed the polling, the client 270 stores a polling termination time, which is a time at which the client has performed the polling, and a sequence (last_seq) number of the last read trap, in the client list table 260. This polling task is repeatedly performed according to a set period.

When the fault manager is normally terminated and accordingly, the connection is terminated, the client 270 performs a task of deleting its information from the client list table 260.

According to the present invention as described above, it is possible to process a large amount of trap congestion caused upon system fault and instability, and to minimize a loss during trap processing. Further, the processing and storage of numerous real-time traps (e.g., 200 or more TPS) become possible which is required in high-capacity integrated network management, thereby realizing 200 or more trap processing per second as compared to a conventional about 20 to 30 trap processing per second.

The present invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

Although the technical spirit of the present invention has been described in connection with the accompanying drawings, it is intended to illustrate preferred embodiments of the present invention and not to limit the present invention. Further, it will be apparent that a variety of variations and imitations of the present invention may be made by those skilled in the art without departing the spirit and scope of the present invention.

With the present invention, the temporary storage of the traps in the listener table is simply performed by the fault management module and other additional functions spending time are performed by adopting an asynchronous transaction processing manner through the listener daemon module in order to more rapidly and quickly process a large amount of alarm and event information which could not be satisfied in an existing synchronous manner, thereby realizing real-time processing of a plurality of traps.

1. A method of processing fault information in a network management system, the method comprising:
a first process of collecting and storing fault generation information in a listener table, by a fault management module;
a second process of periodically deleting the fault generation information in said listener table on a partition-by-partition basis, by a listener daemon module; and
a third process of updating the fault generation information in an alarm table and an event table and processing a representative alarm, by the listener daemon module.

2. The method according to claim 1, wherein, in said first process, said fault management module parses and stores the collected fault generation information.

3. The method according to claim 1, wherein, in said first process, said fault management module stores the collected fault generation information in said listener table by periodically performing a bulk commit.

4. The method according to claim 1, wherein the fault generation information partitions in said second process are formed on the basis of a certain time.

5. The method according to claim 1, wherein the deletion of said fault generation information on a partition-by-partition basis in said second process refers to deleting old data partitions periodically.

6. The method according to claim 1, wherein said storage of the fault generation information to update the fault generation information in said alarm table and said event table by the listener daemon module in said third process is performed by a bulk commit.

7. The method according to claim 1, wherein said third process selects the representative alarm from a data package for a bulk commit for updating the fault generation information.

8. A network management system for enhancing a fault information processing speed, comprising:
a fault management module for collecting fault generation information from a network;
a listener table for storing the fault generation information periodically sent from said fault management module; and
a listener daemon module for deleting the fault generation information in said listener table on a partition-by-partition basis, updating the fault generation information in an alarm table and an event table, and selecting a representative alarm.

9. The system according to claim 8, wherein said fault management module parses and stores the collected fault generation information.

10. The system according to claim 8, wherein said fault management module stores the collected fault generation information in said listener table by periodically performing a bulk commit.

11. The system according to claim 8, wherein said listener table forms partitions on the basis of a certain time.

12. The system according to claim 8, wherein said listener daemon module performs a bulk commit to update the fault generation information in said alarm table and said event table.

13. The system according to claim 8, wherein said listener daemon module selects the representative alarm from a data package for a bulk commit for updating the fault generation information.

14. The system according to claim 8, wherein said listener daemon module periodically deletes old data partitions to delete the fault generation information on a partition-by-partition basis.

15. A method of processing fault information in a network management system, the method comprising:
when a trap generated in the network arrives at a fault management module, parsing, by said fault management module, the arrived trap data into a storable format and then temporarily storing in a listener table;
when the trap arrives, driving a timer for said fault management module to perform a bulk commit periodically;
periodically fetching, by a listener daemon module, all trap information following the last sequence from said listener table;
storing, by said listener daemon module, the trap information fetched from said listener table, in an alarm table and an event table;
performing collective representative alarm selection according to the selected class by said listener daemon module;
periodically deleting fault generation information in said listener table on a partition-by-partition basis by periodically deleting, by said listener daemon module, old data partition, the alarm information stored in said listener table being for polling by the clients, the already polled information being periodically deleted and with the periodic deletion, the storage in said listener table being temporary storage; and
monitoring, by said listener daemon module, said client list table and comparing the monitoring time to the last polling time of the client to determine whether the abnormal termination is made or not, when it is determined there is abnormal termination, then deleting by said listener daemon module, the list of abnormally terminated clients from said client list table.

16. The method of claim 15, further comprising of:
running, by the client, said fault manager, and then registering an identifier of the client on said client list table by an initial running, the client writing its running time information, and receiving an allocated identifier of the client identifier.

17. The method of claim 16, further comprising of:
after registering the identifier on said client list table, inquiring, by the client, of whether new alarm data is present, and the client performing polling to confirm whether newly arrived alarm information is present in said listener table, and checking whether a number larger than the last sequence number is present to confirm whether the new alarm data arrives.

18. The method of claim 17, further comprised of periodically fetching all traps following the last sequence by periodically polling said listener table to fetch newly arrived alarms, where the last sequence is used to distinguish the newly arrived alarms, and the last sequence, is the sequence number of the last alarm that is read when the clients periodically perform alarm polling.

19. The method of claim 17, wherein said listener daemon module stores the trap information, fetched from said listener table, in said alarm table when it is an alarm, and records the trap information in said alarm table when fault release is generated.

20. The method of claim 19, wherein when overlapped alarm is generated, the listener daemon module accordingly performs a generation count increment.

21. The method of claim 17, wherein said alarm table is formed of a table representing the generation or non-generation, generation times of a particular alarm, whenever faults are individually generated, the generation release or non-generation release and overlapped generation or non-overlapped generation are recorded in said alarm table and the fault generation information is updated.

22. The method of claim 17, wherein, when storing the trap information fetched from said listener table in said alarm table and said event table, said listener daemon module performs the bulk commit in which data is packaged and is collectively processed with a class in the data package showing the highest fault degree being selected.

23. The method of claim 17, further comprised of upon deleting old data including already read data, among alarm information stored in said listener table, deleting the stored data group on a partition-by-partition basis without finding and deleting the old data one by one, at this time, the partitions are created at certain intervals, and alarms contained in the certain interval are all stored in the same partition, when the time has elapsed, the old partition of the certain interval unit is deleted where the data contained in the partition is deleted at one time.

24. The method of claim 17, wherein said listener daemon module periodically deletes a list of abnormally terminated clients from said client list table, when said alarm manager has been normally terminated, each of the clients no longer performing the polling and deleting its information from said client list.

25. The method of claim 17, wherein said client performing direct network management by connecting to the network management system and collecting necessary network fault information.

26. A network management system for enhancing a fault information processing speed, comprising:
a fault management module parsing the arrived trap data into a storable format and then temporarily storing in said listener table, when a trap generated in the network arrives at said fault management module, when the trap arrives, driving a timer for said fault management module to perform a bulk commit periodically; and
a memory including a listener daemon module periodically fetching all trap information following the last sequence from said listener table, said listener daemon module storing the trap information fetched from said listener table, in said alarm table and said event table, said listener daemon module performing collective representative alarm selection according to the selected class by, said listener daemon module periodically deleting fault generation information on a partition-by-partition basis by periodically deleting old data partition, the alarm information stored in said listener table being for polling by the clients, the already polled information being periodically deleted and with the periodic deletion, the storage in said listener table being temporary storage, said listener daemon module monitoring said client list table and comparing the monitoring time to the last polling time of the client to determine whether the abnormal termination is made, when it is determined there is abnormal termination, then deleting by said listener daemon module, the list of abnormally terminated clients from said client list table, the client registering an identifier of the client on said client list table, the client writing its running time information, and receiving an allocated identifier of the client identifier, after registering the identifier on said client list table, inquiring, by the client, of whether new alarm data is present, and the client performing polling to confirm whether newly arrived alarm information is present in said listener table, and checking whether a number larger than the last sequence number is present to confirm whether the new alarm data arrives.

27. A computer-readable medium having computer-executable instructions for performing a method of processing fault information in a network management system, comprising:
when a trap generated in the network arrives, parsing the arrived trap data into a storable format and then temporarily storing in a first table;
when the trap arrives, performing a bulk commit periodically;
periodically fetching all trap information following the last sequence from said first table;
storing the trap information fetched from said first table, in a second table and said third table;
performing collective representative alarm selection according to the selected class;
periodically deleting fault generation information in said first table on a partition-by-partition basis by periodically deleting old data partition, the alarm information stored in said first table being for polling by the clients, the already polled information being periodically deleted and with the periodic deletion, the storage in said first table being temporary storage, upon deleting old data including already read data, among alarm information stored in said first table, deleting the stored data group on a partition-by-partition basis without finding and deleting the old data one by one;
monitoring a fourth table and comparing the monitoring time to the last polling time of the client to determine whether the abnormal termination is made or not, when it is determined there is abnormal termination, then deleting the list of abnormally terminated clients from said fourth table;
registering an identifier of the client on said fourth table, the client writing its running time information, and receiving an allocated identifier of the client identifier; and
after registering the identifier on said fourth table, inquiring, by the client, of whether new alarm data is present, and the client performing polling to confirm whether newly arrived alarm information is present in said first table, and checking whether a number larger than the last sequence number is present to confirm whether the new alarm data arrives.

28. A computer-readable medium having stored thereon a data structure comprising:
a first field containing data representing collecting and storing fault generation information in a listener table, by a fault management module;
a second field containing data representing periodically deleting the fault generation information in said listener table on a partition-by-partition basis, by a listener daemon module; and
a third field containing data representing updating the fault generation information in an alarm table and an event table and processing a representative alarm, by the listener daemon module.
